(19) United States
(12) Patent Application Publication
(10) Pub. No.: US 2012/0280822 A1
(43) Pub. Date: Nov. 8, 2012

(54) POWER RECEPTACLE CURRENT DISPLAYING AND ALERT DEVICE FOR DETECTING CURRENT STATE OF POWER RECEPTACLE AND RECEPTACLE HAVING THE SAEM

(76) Inventor: Kuei-Wei Kuo, Hsinchu County (TW)

(21) Appl. No.: 13/098,489

(22) Filed: May 2, 2011

(51) Int. Cl. G08B 21/00

(52) U.S. Cl. 340/664

(57) ABSTRACT

A power receptacle current displaying and alert device comprises a panel; a current sensor being a C silicone steel sheet; a coil winding around the C silicone steel sheet for sensing the current of the power receptacle; a current detector being a Hall IC; the Hall IC being installed at a notch of the C silicone steel sheet so as to detect the current flow in the power wire of the power receptacle; the Hall IC detecting the current electromagnetically; the current detector including an integrated circuit; the integrated circuit can transfer the value about the current state of the power receptacle for displaying; and a display for displaying a current state from the integrated circuit; a sound alarm, a light alarm and a transmitter for alerting the statues of the current of the power receptacle to users. A power receptacle using the device is also provided.

### FIELD OF THE INVENTION

The present invention relates to power receptacles, in particular to a power receptacle current displaying and alert device for detecting a current state of a power receptacle and a receptacle with the device is also provided.

### BACKGROUND OF THE INVENTION

Safety about usages of electric devices are important due to more and more electric devices are used in various places. Currently, to assure the safety of electric devices, fuses or circuit breakers installed for protection of the electric devices, but the users can not known the current states in advance. The user updates the fuse or close the breakers after an accident occurs. However this is a trouble to users since the users face a problem that the electric devices will be interrupted in use even some desired functions can not be achieved in the period.

It is often that a plurality of electric devices are plugged into a same receptacle so that the current load to the receptacle is great and the user faces a danger of over-current. However this is a potential threat to the daily life.

Although a current detector can be used to detect the current at outside of a power receptacle, but the user must prepare a current detector and take the detector to perform the action of detection. This is inconvenient and generally, the user cannot always perform the action of the current detection for getting the current state of a power receptacle.

Therefore, there is an eager demand for a novel design which can resolve the above mentioned problem.

### SUMMARY OF THE INVENTION

Accordingly, the object of the present invention is to provide a power receptacle current displaying and alert device for detecting current state of a power receptacle, wherein the device provides a precaution alert to users so that the user can make a pre-action.

Furthermore, the present invention provides the user to know the current state for the receptacles.

To achieve above object, the present invention provides a power receptacle current displaying and alert device for detecting a current state of a power receptacle, comprising: a panel; a current sensor being a C silicone steel sheet; a coil winding around the C silicone steel sheet; the C silicone steel sheet surrounding a power wire of the power receptacle for sensing the current of the power receptacle; when current flows through the power wire of the power receptacle; the coil will sensing the current; a current detector being a Hall IC; the Hall IC being installed at a notch of the C silicone steel sheet so as to detect the current flow in the power wire of the power receptacle; the Hall IC detecting the current electromagnetically; the current detector including an integrated circuit; the integrated circuit can transfer the value about the current state of the power receptacle for displaying; and a display for displaying a current state from the integrated circuit.

The present invention also includes a sound alarm, a light alarm and a transmitter for alerting the statues of the current of the power receptacle to users.

Moreover, the present invention also provides a power receptacle using the above mentioned current displaying and alert device.

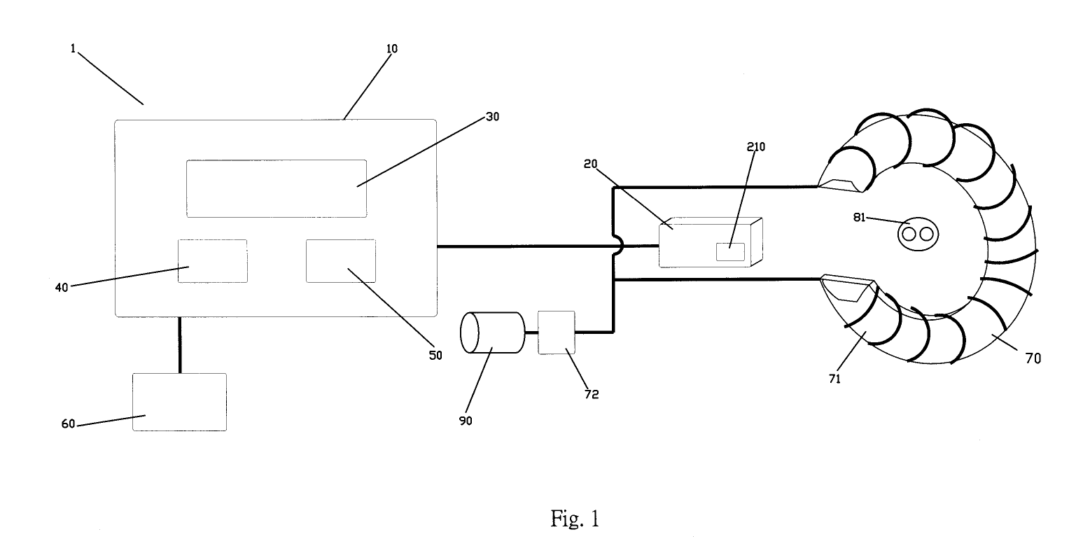

FIG. 1 is a perspective view showing the preferred embodiment of the present invention.

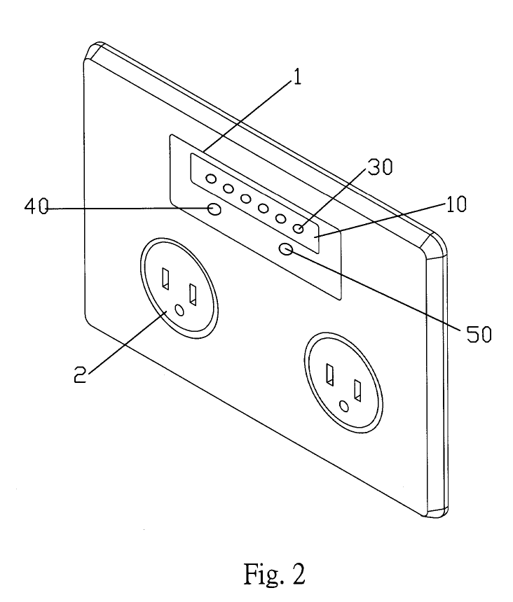

FIG. 2 shows the panel of the present invention.

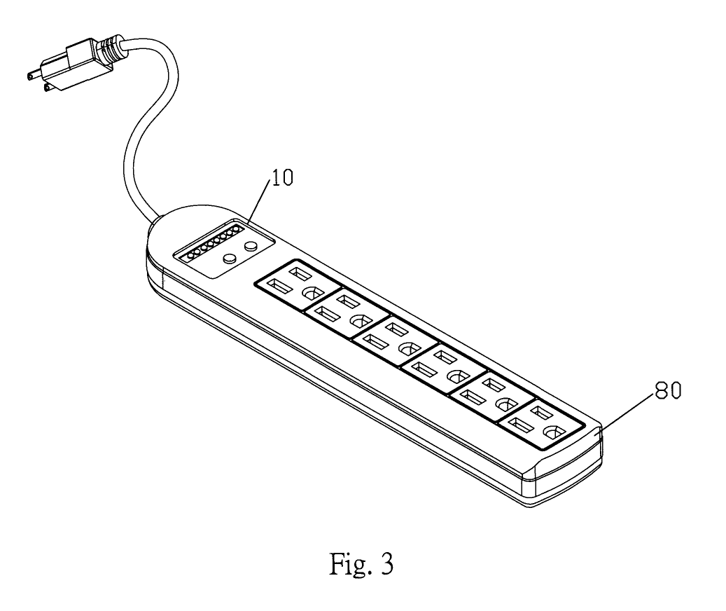

FIG. 3 shows the application of the present invention, where an receptacle with an extension line is installed with the structure of the present invention.

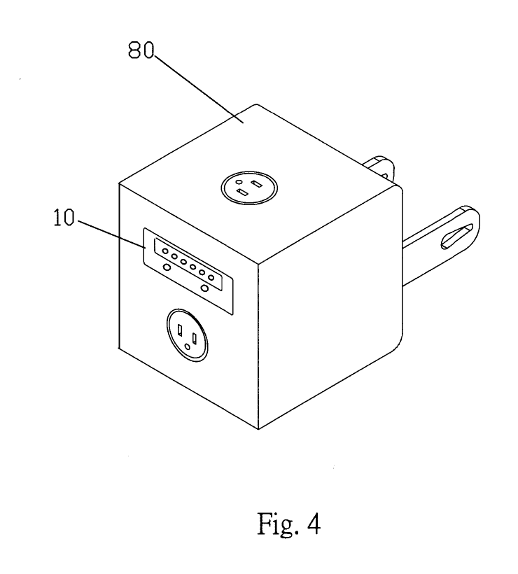

FIG. 4 shows the structure of the present invention is integrated to an insertion receptacle.

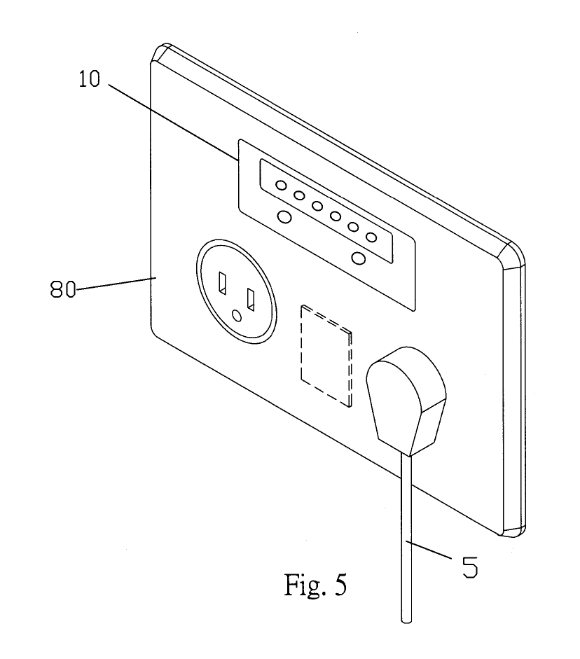

FIG. 5 shows an application of the present invention, wherein the receptacle is inserted by a plug.

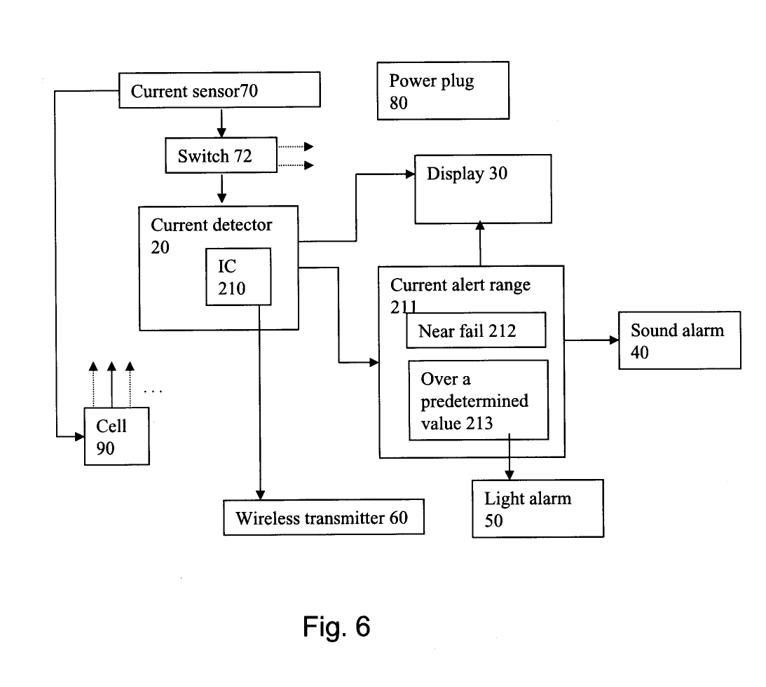

FIG. 6 is a block diagram showing the structure of the present invention.

### DETAILED DESCRIPTION OF THE INVENTION

In order that those skilled in the art can further understand the present invention, a description will be provided in the following in details. However, these descriptions and the appended drawings are only used to cause those skilled in the art to understand the objects, features, and characteristics of the present invention, but not to be used to confine the scope and spirit of the present invention defined in the appended claims.

Referring to FIGS. 1 to 6, a preferred embodiment about the current display and alarm device for a power receptacle according to the present invention is illustrated. The device of the present invention comprises the following elements.

A panel 10 is preferably integrated into a panel of the power receptacle. The panel 10 serves to install with a display 30, a sound alarm 40, and a flash alarm 50.

A current sensor 70 is preferably a C silicone steel sheet. A coil 70 winds around the C silicone steel sheet. The C silicone steel sheet surrounds a power wire 81 of the power receptacle 80 for sensing the current of the power receptacle 80. When current flows through the power wire 81 of the power receptacle 80. The coil 71 will sense the current. Two ends of the coil 71 will output the current to a switch 72 which serves to turn on or off the operation of the present invention. When the current flows through the power wire 81, the C silicone steel sheet will be induced with current to actuate the switch 72. On the contrary, when no current flows through the power wire 81, no current will flow to the switch 72 from the coil 72, and thus the switch 72 will turn off so as to save power required in the present invention. Furthermore, the current from the coil 72 can be used as a current for operating the system of the present invention. However when the current is too low to operate the present invention, a cell (or battery is necessary).

A current detector 20 is preferably a Hall IC. The Hall IC can be installed at a notch of the C silicone steel sheet so as to detect the current flow in the power wire 81 of the power receptacle 80. The Hall IC detects the current by electromagnetic theory. The current detector 20 includes an integrated circuit 210. The integrated circuit 210 can transfer the value about the current state of the power receptacle 80 for displaying. When the current of the power wire 81 is near a predetermined alert value 211, the integrated circuit 210 will emit an alert signal to related alert devices (step 212). When the current of the power wire 81 is over a predetermined value which causes the current in the power wire 81 is interrupted, the integrated circuit 210 will transfer an alarm signal to related devices (step 213).

A cell 90 serves to provide electric power to the elements of the present invention. The cell 90 can be connected the coil 72 of the C silicone steel sheet for power charging.

A display 30 is a display of any form, such as an LED display or a plurality of lamps for displaying the current strength. The current value detected by the integrated circuit 210 of the current detector 20 can be transferred to the display 30 for displaying.

A sound alarm 40 serves to receive the signals from the integrated circuit 210. When the current detector 20 detects the current is near a predetermined value (step 212) or over the predetermined value (step 213), the states will be transferred to the sound alarm 40 for alerting the user.

A light alarm 50 serves to receive the signals from the integrated circuit 210. When the current detected by the current detector 20 is near a predetermined value (step 212) or over the predetermined value (step 213), the detected states will be transferred to the light alarm 50 for alerting the user.

A wireless transmitter 60 serves to receive the signals from the integrated circuit 210. When the current detector 20 detects the current is near a predetermined value (step 212) or over the predetermined value (step 213), the states will be transferred to the wireless transmitter 60 for alerting a remote user.

The operation of the present invention will be described herein. When the power receptacle 80 is loaded, the coil 71 of the C silicone steel sheet will sense the current in the power wire 81 so as to generate an induced current to actuate the switch 72. The current detector 20 will detect the current value in the power wire 81. The integrated circuit 210 of the current detector 20 transfers this current value to the display 30 for displaying. Moreover, the current value is compared with a predetermined value set in the integrated circuit 210. If the current value for the power wire 81 is near the predetermined value set in the integrated circuit 210, a near fail signal is transferred to the sound alarm 40 or the light alarm 50 for alerting the user that the current of the power wire 81 is near a fail state. If the current in the power wire 81 is interrupted, a fail signal is transferred to the sound alarm 40 or the light alarm 50 to alert the user for the state with different alert signal.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A power receptacle current displaying and alert device for detecting a current state of a power receptacle, comprising:
a panel;
a current sensor being a C silicone steel sheet; a coil winding around the C silicone steel sheet; the C silicone steel sheet surrounding a power wire of the power receptacle for sensing the current of the power receptacle; when current flows through the power wire of the power receptacle; the coil will sensing the current;
a current detector being a Hall IC; the Hall IC being installed at a notch of the C silicone steel sheet so as to detect the current flow in the power wire of the power receptacle; the Hall IC detecting the current electromagnetically; the current detector including an integrated circuit; the integrated circuit can transfer the value about the current state of the power receptacle for displaying; and
a display for displaying a current state from the integrated circuit.

2. The power receptacle current displaying and alert device as claimed in claim 1, wherein when the current of the power wire is near a predetermined alert value, the integrated circuit will emit an alert signal to related alert device; when the current of the power wire is over a predetermined value which causes the current in the power wire is interrupted, the integrated circuit will transfer an alarm signal to related devices.

3. The power receptacle current displaying and alert device as claimed in claim 1, wherein two ends of the coil outputs the current from the coil to a switch which serves to turn on or off the operation of the device.

4. The power receptacle current displaying and alert device as claimed in claim 1, wherein the current from the coil is used to operate the device.

5. The power receptacle current displaying and alert device as claimed in claim 1, further comprising:
a cell for providing electric power to the elements of the device.

6. The power receptacle current displaying and alert device as claimed in claim 5, wherein the cell is connected the coil of the C silicone steel sheet for power charging.

7. The power receptacle current displaying and alert device as claimed in claim 2, further comprising:
a sound alarm for receiving the signals from the integrated circuit and alerting the current state of the power wire.

8. The power receptacle current displaying and alert device as claimed in claim 2, further comprising:
a light alarm for receiving the signals from the integrated circuit and alerting the current state of the power wire.

9. The power receptacle current displaying and alert device as claimed in claim 2, further comprising:
a wireless transmitter for receiving the signals from the integrated circuit and alerting the current state of the power wire to a remote user.

10. The power receptacle current displaying and alert device as claimed in claim 1, wherein the display is one of an LED display and a plurality of lamps.

11. A power receptacle with a current displaying and alert device, comprising:
a power receptacle;
a panel;
a current sensor being a C silicone steel sheet; a coil winding around the C silicone steel sheet; the C silicone steel sheet surrounding a power wire of the power receptacle for sensing the current of the power receptacle; when current flows through the power wire of the power receptacle; the coil will sensing the current;
a current detector being a Hall IC; the Hall IC being installed at a notch of the C silicone steel sheet so as to detect the current flow in the power wire of the power receptacle; the Hall IC detecting the current electromagnetically; the current detector including an integrated circuit; the integrated circuit can transfer the value about the current state of the power receptacle for displaying; and
a display for displaying a current state from the integrated circuit.

12. The power receptacle current displaying and alert device as claimed in claim 1, wherein when the current of the power wire is near a predetermined alert value, the integrated circuit will emit an alert signal to related alert device; when the current of the power wire is over a predetermined value which causes the current in the power wire is interrupted, the integrated circuit will transfer an alarm signal to related devices.

13. The power receptacle current displaying and alert device as claimed in claim 11, wherein two ends of the coil outputs the current from the coil to a switch which serves to turn on or off the operation of the device.

14. The power receptacle current displaying and alert device as claimed in claim 11, wherein the current from the coil is used to operate the device.

15. The power receptacle current displaying and alert device as claimed in claim 11, further comprising:
a cell for providing electric power to the elements of the device.

16. The power receptacle current displaying and alert device as claimed in claim 15, wherein the cell is connected the coil of the C silicone steel sheet for power charging.

17. The power receptacle current displaying and alert device as claimed in claim 12, further comprising:
a sound alarm for receiving the signals from the integrated circuit and alerting the current state of the power wire.

18. The power receptacle current displaying and alert device as claimed in claim 12, further comprising:
a light alarm for receiving the signals from the integrated circuit and alerting the current state of the power wire.

19. The power receptacle current displaying and alert device as claimed in claim 12, further comprising:
a wireless transmitter for receiving the signals from the integrated circuit and alerting the current state of the power wire to a remote user.

20. The power receptacle current displaying and alert device as claimed in claim 11, wherein the display is one of an LED display and a plurality of lamps.
